(19) United States
(12) Patent Application Publication
(10) Pub. No.: US 2021/0288493 A1
(43) Pub. Date: Sep. 16, 2021

(54) OPTIMIZATION OF POWER GENERATION FROM POWER SOURCES USING FAULT PREDICTION BASED ON INTELLIGENTLY TUNED MACHINE LEARNING POWER MANAGEMENT

(71) Applicant: ComAp a.s., Prague (CZ)

(72) Inventors: Bhuneshwar Prasad, Singapore (SG); Swardheep Babu, Singapore (SG); Nigel Watson, Belair (AU)

(21) Appl. No.: 17/198,693

(22) Filed: Mar. 11, 2021

Related U.S. Application Data
(60) Provisional application No. 62/988,641, filed on Mar. 12, 2020.

(51) Int. Cl. H02J 3/00

(52) U.S. Cl. CPC H02J 3/001; H02J 2203/20; H02J 3/003

(57) ABSTRACT

A power source fault prediction and control system includes a plurality of power sources, such as generator sets connected in parallel, a controller, and a data acquisition and analysis module. The data acquisition and analysis module is configured to receive sensor data from a sensor, analyze the sensor data, predict a future fault scenario at a first time, and optionally send an instruction to the controller to change an operational parameter of a respective power source, such as the generator set. The instruction is configured to delay the fault scenario to a second time after the first time.

### RELATED APPLICATIONS

This application claims the benefit of and priority to U.S. Provisional Patent Application No. 62/988,641 filed Mar. 12, 2020, entitled “OPTIMIZATION OF POWER GENERATION FROM GENERATOR SETS USING FAULT PREDICTION BASED ON INTELLIGENTLY TUNED MACHINE LEARNING POWER MANAGEMENT”, which is incorporated herein by reference in its entirety.

### BACKGROUND

Power sources, such as batteries, generator sets or “gensets”, and other renewable resources (e.g., solar cells, wind turbines, etc.) are widely used to provide electric power especially in areas that are far from or not connected to a power grid. A genset typically includes an engine coupled to an alternator, which converts the rotational energy from the engine into electrical energy. Typically, a controller controls and monitors the operation of a genset and/or other power sources, including the operation of the engine and alternator of the genset. The controller may provide control signals to the genset such that the genset operates at optimal performance. For maintenance purposes, the controller may power down a genset to perform scheduled maintenance.

### SUMMARY

The present disclosure provides improved fault prediction and control systems, devices and methods based on machine learning to optimize power generation. In an example, a system includes a plurality of generator sets connected in parallel, a controller, and a data acquisition and analysis module. The data acquisition and analysis module is configured to receive sensor data from a sensor, analyze the sensor data, predict a future genset fault scenario at a first time, and send an instruction to the controller to change an operational parameter of a generator set. The instruction is configured to delay the fault scenario to a second time after the first time.

In another example, a method includes measuring current operating values for a generator set that is configured with first operating conditions, estimating a safe operation window for the generator set, and comparing the safe operation window to a warning criteria. The method also includes calculating second operating conditions for the generator set. The second operating conditions are different than the first operating conditions. Additionally, the method includes reallocating a genset load for the generator set based on the second operating conditions for the generator set.

In another example, a method includes establishing limits for sensor data. The sensor data is obtained by one or more sensors configured to monitor a generator set. The method also includes initializing a first cost function weight and a second cost function weight associated with the sensor data, determining convergence values for the first cost function weight and the second cost function weight using machine learning, and outputting a trend line based on the sensor data based on a regression analysis of the sensor data and the convergence values for the first cost function weight and the second cost function weight. Additionally, the method includes dynamically adjusting at least one operating parameter of the generator set based on the fault scenario prediction. The at least one operating parameter is related to the sensor data.

Additional features and advantages of the disclosed fault prediction and control systems, devices and methods are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE FIGURES

FIG. 1 is a schematic view of a generator set fault prediction and control system according to an example embodiment of the present disclosure

FIG. 2 is a schematic view of various sensor locations on a generator set according to an example embodiment of the present disclosure.

FIG. 3A is a schematic view of sensor interfaces of a data acquisition and analysis module according to an example embodiment of the present disclosure.

FIG. 3B is a schematic view of a controller according to an example embodiment of the present disclosure.

FIG. 4 illustrates an example user interface of a controller display according to an example embodiment of the present disclosure.

FIG. 5 illustrates an example flowchart of an example process for predicting a fault scenario and reallocating genset load according to an example embodiment of the present disclosure.

FIG. 6 illustrates an example flowchart of an example process for predicting a fault scenario according to an example embodiment of the present disclosure.

FIGS. 7A, 7B, and 7C illustrate an example analysis performed by a data acquisition and analysis module for fault prediction according to example embodiments of the present disclosure.

FIG. 8 illustrates an example mapping of a predicted fault scenario trend line in various operational zones according to an example embodiment of the present disclosure.

### DETAILED DESCRIPTION OF EXAMPLE EMBODIMENTS

As discussed above, fault prediction and control systems, devices and methods are provided to optimize power generation based on machine learning power management. Typically multiple generator sets (“gensets”) are connected in parallel where some of the gensets are active while others are in standby mode. For example, a network or chain of gensets may generate power together by sharing a load (e.g., by different combinations of the gensets operating together and/or different gensets operating under different operational parameters based on the power output demand). Due to continuous operation of the system, the gensets, when in parallel operation, typically share the load with multiple other gensets in the system. Other power sources may also operate with the gensets to share the load. For example, power generation may be optimized between gensets, renewable energy resources (e.g., solar cells, wind turbines), other energy resources (e.g., hydrogen cells) and energy storage systems (e.g., batteries).

During operation, the power sources, such as the gensets, experience various stresses, such as mechanical stresses (e.g., vibrations), temperature stress (e.g., on alternator windings, on oil-cooled components, and in the manifold and/or exhaust due to rising temperatures), fuel leakage, drop in pressure levels of oil and coolant substances, etc. Each of the power sources (e.g., gensets, renewable energy resources, etc.) may also experience electrical stress such as drop in battery voltage levels due to a failure of chargers or due to a breakdown of active sensors. Such failures may ultimately cause severe damages to the power sources (e.g., gensets) in the network, which may lead to a breakdown of the network of power resources, such as the chain of gensets connected in parallel. A breakdown of the network of power sources (e.g., gensets, renewable energy resources, etc.) may cause a catastrophic drop in the generated power output of the network.

To prevent breakdown of the network, maintenance events may be scheduled to repair and replace components of the energy resources (e.g., genset components) and other non-power providing devices (e.g., controllers, communication devices, inverters, etc.) to ensure healthy operation of the network of energy resources (e.g., gensets, renewable energy resources, etc.). Typically, a static approach is used to either (1) perform reactive maintenance (e.g., failure-based maintenance that is performed after a failure occurs) or (2) for scheduled or preventative maintenance that replaces components or repairs components on a set maintenance schedule. However, a static maintenance approach is often either performed too late in the case of reactive maintenance or too early in the case of preventative maintenance. Additionally, the static approach is unable to predict or prevent sudden faults or failures that unexpectedly occur (e.g., to changes in the operational environment). Sudden faults or failures may lead to unplanned power outages because even though scheduled or preventative maintenance may prevent most failures, system reliability may still be affected from sudden faults or failures that are not addressed by scheduled maintenance.

In several of the examples described below, a genset or genset(s) may be described in particular for illustrative purposes. However, it should be understood that the examples and description provided with respect to genset(s) (e.g., power optimization, control, fault predictions, etc.) may also apply to other power sources (e.g., hydrogen cells), renewable energy resources (solar cells, wind turbines, etc.) and energy storage systems (e.g., batteries). It should also be appreciated that the disclosure may also apply to non-power providing devices, such that controller(s), communication devices, inverters and other system components may be monitored for health and maintenance to ensure the network up-time is maximized.

As used herein, a “non-power source” is any device, component or piece of equipment used to control, communicate, monitor or otherwise interact with any of the power sources of the system. For example, a “non-power source” may be a sensor, a controller, an inverter etc.

In an illustrative example, under a sudden fault or failure scenario as described above, the failure of a single component in one genset may negatively affect the reliability of the entire genset network. As described above, multiple gensets may share an active load, but when a sudden fault occurs in one of the gensets, the entire network may be at risk. For example, if a genset is taken offline, other gensets in the network may have to account for and take on additional load (e.g., that was previously handled by the genset taken offline) to satisfy the energy demands. Taking on additional load unexpectedly by another genset in the network may cause other faults or failure scenarios in that genset. For example, alternator winding temperature may spike above the defined limits due to an increased load, which can completely shut down additional gensets. In other cases, heavy load operations may cause additional vibration in the generator due to loosening of fastenings, which can lead to misalignment of the alternator. These events can cause deteriorated performance of the machine leading to steady drop in efficiency, thereby causing other generators to again increase their share of the active load, which creates a destructive cycle that can quickly take an entire network of gensets offline. As noted above, the illustrative example of the failure of a single component in one genset may also negatively affect the reliability of the entire network of power sources. For example, genset failures may affect the reliability of other power sources in the network. Similarly, failures of other power sources (e.g., renewable energy resources) may affect the reliability of the gensets, batteries, hydrogen cells, etc. in the network.

Furthermore, from a reliability, availability, maintainability and safety (“RAMS”) point of view, sudden faults or failures may also lead to extended down-time when a static maintenance schedule is used due to the unavailability of a technician or spare parts and the delay of mobilization of the required resources to resolve the problem. For example, power sources (e.g., gensets) may be located on sites far from operators or technicians, which can cause delays in obtaining spare parts or waiting for a technician to arrive. However, the predictive capabilities of the systems and methods disclosed herein allows for failure scenarios to be prevented so that maintenance events to be more appropriately scheduled based on the availability of technicians and spare parts by modifying operation parameters (e.g., sending control instructions) to extend the healthy operational life of the network of power sources. The capabilities of the systems and methods disclosed herein reduces down-time and reduces maintenance, travel and on-site staffing costs associating with running a genset facility and other power facilities.

To reduce the frequency of maintenance events, prevent sudden or unexpected failures, and to reduce downtime, the systems and methods disclosed herein advantageously allow for a dynamic predict maintenance schedule. Predictive maintenance or condition-based maintenance is performed right-on-time or just-in-time instead of being too early or too late. For example, predictive maintenance of diesel/gas power gensets provides the ability to predict future failures in advance through optimized computations, which advantageously provides more up-time for the genset network to meet rapidly growing energy demands. Predictive maintenance may also provide more up-time for other power sources (e.g., renewable energy resources, hydrogen cells, batteries, etc.) as well as non-power sources by predicting future failures and taking mitigating actions before the failures occur. Determining various possible future faults or failures may be achieved through machine learning with an objective to maximize the power generated by the assets (e.g., diesel/gas power gensets, renewable energy resources, hydrogen cells, etc.). The power generated by a power sources, such as a genset, depends on the specific engine and alternator model as well as the operating parameters (e.g., optimal operating parameters will result in higher power output).

Condition based machine learning algorithms are designed to minimize maintenance, reduce operation down-time, and generate the maximum power by the power source (e.g., genset). Therefore, accurate modeling of sensor data is vital to achieve optimized power generation. For example, the systems and methods disclosed herein may obtain data from an array of sensor interfaces to different components of a generator set, renewable energy resources, etc. The collected data may then be analyzed to accurately predict a future failure scenario that is expected to occur (e.g., from a predicted or expected component failure). In an example, an intelligent tuned machine learning (e.g., Neural Network) algorithm along with a linear regression technique may be used to obtain optimal operation parameters (e.g., genset operation parameters, wind turbine operation parameters, battery operation parameters, etc.) for each power source (e.g., genset) in the network.

In the event of a predicted failure scenario, a controller or a data acquisition and analysis module may trigger a warning or a shutdown alarm to notify an operator before the failure scenario occurs. Preventing a failure scenario or failure event advantageously protects the power sources (e.g., genset or other power source) in question and also protects the network from a severe breakdown when multiple power sources (e.g., generators) are connected in parallel.

Furthermore, based on predicted failure scenarios, load sharing between multiple power sources (e.g., gensets or other power sources) in the network may be dynamically controlled to prevent the failure scenario altogether or to delay the failure scenario and increase the lifetime of a power source component. For example, the active or real time operation parameters and/or performance parameters of a genset may be modified based on a predicted failure scenario to optimize the health of the entire network. Similarly, the active or real time operation parameters and/or performance parameters of other power sources, such as a renewable energy resource (e.g., wind turbine) may be modified based on a predicted failure scenario to optimize the health of the entire network. The predictive approach discussed herein may be used to determine the optimum load level (kW/KVAR), which may be a ratio of active power (kW) and reactive power (KVAR), for a genset, to determine ideal engine run hours before any breakdown, to automatically start a standby genset for load sharing with the existing system, and to decide on a predictive maintenance schedule among the gensets in a network in order to improve the operation efficiency for each of the individual gensets in the network, which advantageously results in improved overall system efficiency while keeping pace with power generation demand and ensuring safe operational parameters of the system.

In traditional power management systems, the system may monitor the total power demand and compares the power demand to the available supply from the power sources. The systems, methods and techniques disclosed herein may automatically start and stop power sources (e.g., gensets) to coincide with load changes in accordance with any other system factors, such as a pre-set load dependent start-stop. Furthermore, additional factors may be considered for the power sources (e.g., genset start) based on predictive analysis. If the health of the power source (e.g., genset) is below a desired threshold (indicating that the power source is unhealthy), then another power source, such as the next available genset, may be called upon to minimize the fuel consumption of the system.

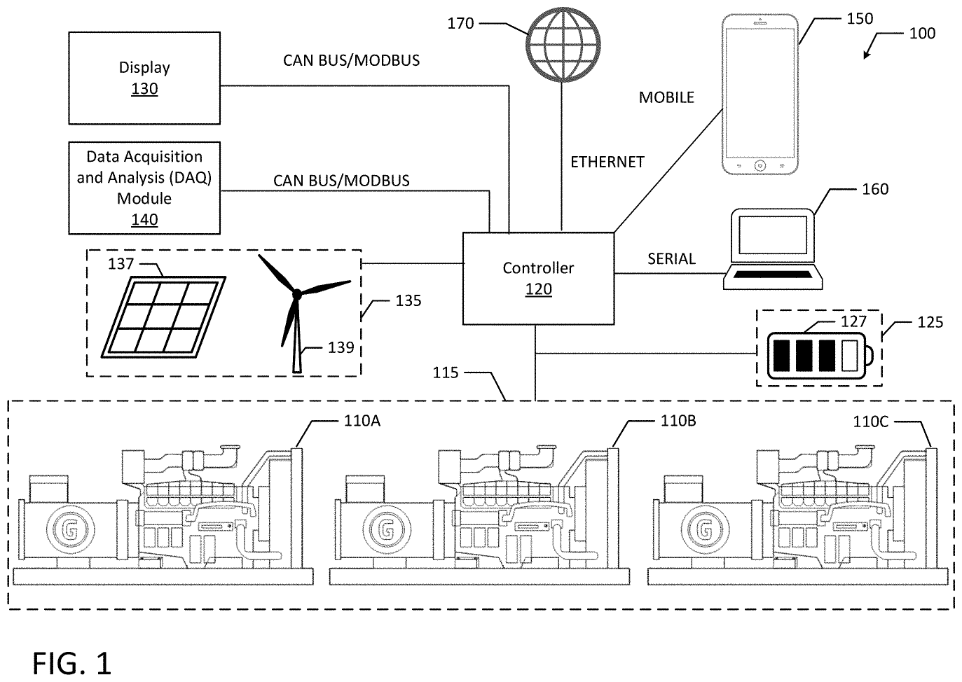

FIG. 1 illustrates a schematic view of a fault prediction and control system 100. The remote monitoring and control system 100 may include a plurality of gensets 110A-C (e.g., gensets 110A-C connected in parallel in chain 115), a power storage system 125 (e.g., system with one or more batteries 127), renewable energy resource(s) 135 (e.g., solar cell(s) 137 and wind turbine(s) 139), other power sources (e.g., hydrogen cells), a controller 120, a display 130, and a data acquisition and analysis module 140. The data acquisition and analysis module 140 may send instructions to the controller 120. Data and other information can be passed from the data acquisition and analysis module 140 to the controller 120 and to other devices such as a mobile phone 150, a computer 160 or other network devices connected to the internet 170. Additionally, the data and other information (e.g., results) may be passed to local data storage or remote storage over a cloud interface. The fault prediction and control system 100 may include any combination and any quantity of the power sources described above. The fault prediction and control system 100 may include a single genset (e.g., genset 110) as well as with multi-genset applications. For example, the techniques disclosed herein are applicable for single genset applications, multi-genset applications, genset and renewable energy resource applications, etc.

The data acquisition and analysis (DAQ) module 140 may be a stand-alone device or machine. In other examples, the DAQ module may be a hardware or software component of another device in system 100 (e.g., a hardware or software component of controller 120). Additionally, the DAQ module 140 may be remote from the controller 120. In an example, the system 100 may include a communication server (not pictured) that routes communication between the controller 120 and the DAQ 140.

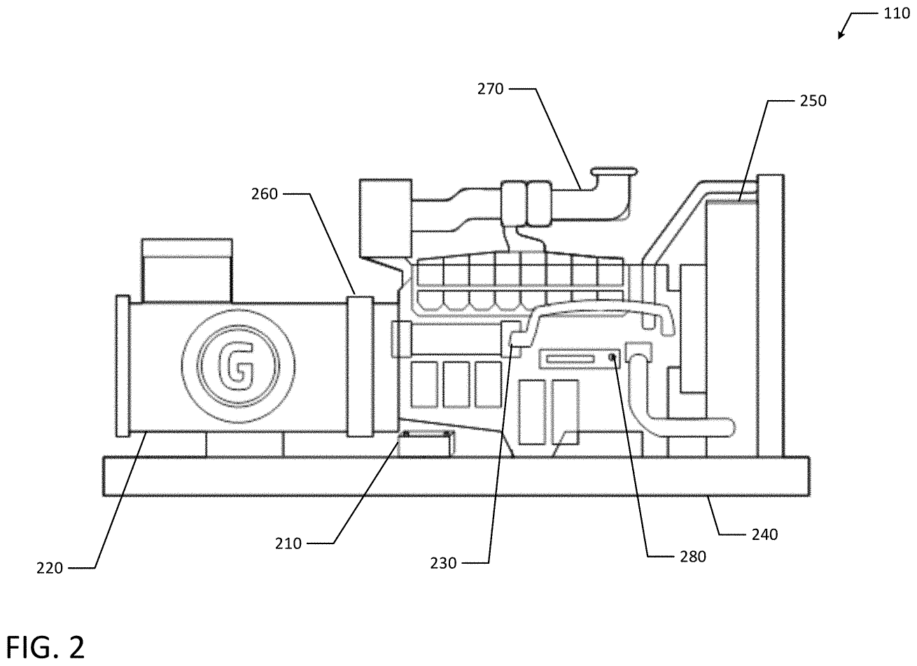

The controller 120 may be installed at a facility in a control room near one or more of the power sources. In an example, the controller 120 may be installed in a genset facility in a control room or near the gensets 110A-C. Each power source (e.g., genset 110A-C) may include various sensors in communication with the controller 120 and/or data acquisition and analysis module 140. For example, as illustrated in FIG. 2, the genset 110 may include a battery monitor 210, an alternator winding temperature sensor 220, a lube oil quality monitor 230, a structural vibration sensor 240, a coolant temperature sensor 250, a bearing failure sensor 260, an exhaust temperature sensor 270, and a lube oil pressure sensor 280, etc. Some additional sensors, not illustrated in include an ambient temperature sensor, a throttle position sensor, an air filter pressure sensor, and a gas flow sensor.

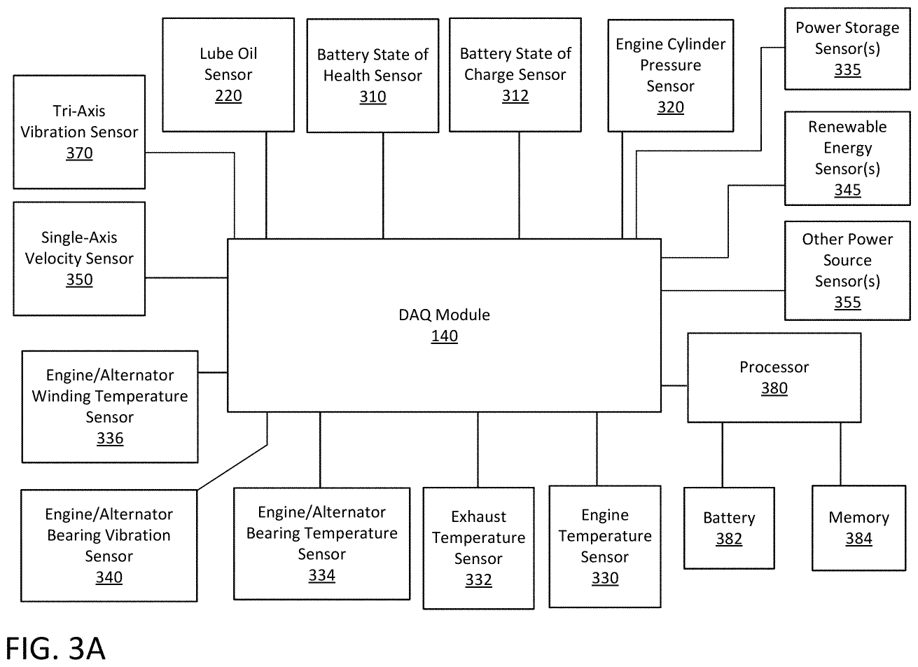

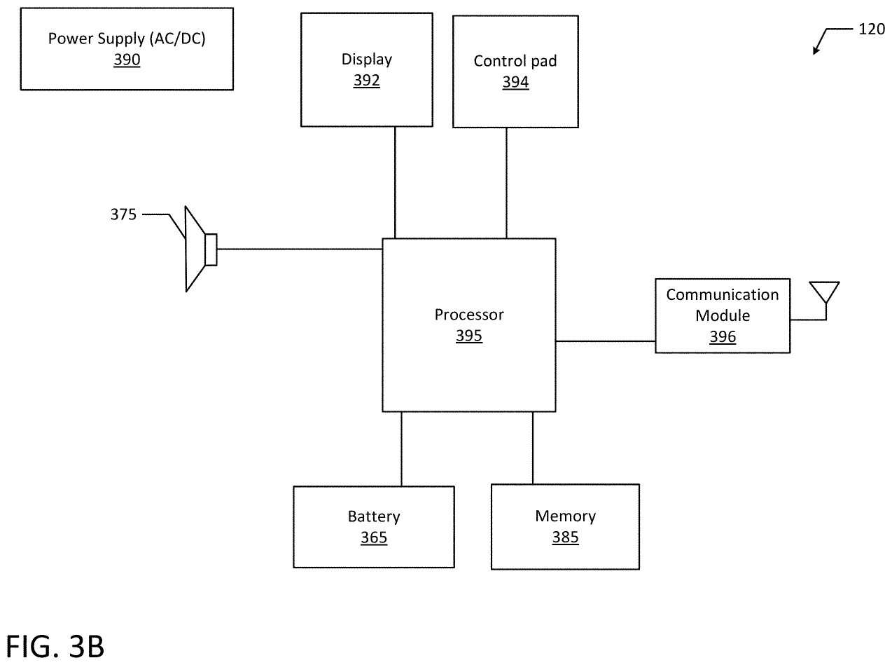

Additionally, the on-site controller 120 and/or DAQ module 140 may be connected to other devices and other controllers, breakers, communication bridges, etc. that can provide additional monitoring and sensor capabilities. For example, FIG. 3A illustrates other examples of sensors that are in communication with and pass data to the DAQ module 140. The various sensor and monitors may include a battery state of health sensor 310, a battery state of charge sensor 312, an engine cylinder pressure sensor 320, an engine temperature sensor 330, an exhaust temperature sensor 332, an engine/alternator bearing temperature sensor 334, an engine/alternator winding temperature sensor 336, an engine/alternator bearing vibration sensor 340, a single-axis velocity sensor 350, a tri-axis vibration sensor 360, and a lube oil sensor 370. Other sensors that may interface with the DAQ module 140 include power storage sensors 335, renewable energy sensor(s) 345 and other power source sensor(s) 355. The renewable energy sensor(s) 345 may include solar cell sensors, wind turbine sensors, etc. The other power source sensor(s) 355 may include sensors associated with hydrogen cells or other power sources in the network.

In another example, non-power sources may be monitored for health via sensors associated with the non-power sources or based on data sets available over communication channels (e.g., MODBUS communication channels for external devices). In an example, battery health, operating temperatures, etc. may be monitored for any of the other non-power sources or non-power devices. Some examples of the non-power sources illustrated in FIG. 1 include display 130, DAQ 140, controller 120, mobile phone 150, computer 160, etc.

The various sensing device(s) and monitors enable a technician or operator to monitor and analyze the operating outputs an review predicted fault information to adjust the operating parameters of a power source, such as genset 110 in the chain 115 (e.g., network of gensets connected in parallel), renewable energy resources 135, power storage system 125, etc. to prevent a failure and extend the operational lifetime of the system. For example, data from the various sensing device(s) and monitors may be sent to the DAQ module 140 and/or controller 120 where it is analyzed to predict future fault scenarios.

Since operating outputs may stray from expected ranges and alarm conditions or critical failure may be abrupt, the ability to continually and reliably monitor and control a genset 110 advantageously reduces failure events and enables the system to take corrective action before a failure event occurs. Taking corrective action by changing operating parameters or scheduling a predictive maintenance event may advantageously extend the life of a specific power source, such as a genset (e.g., genset 110A), or the entire network (e.g., chain 115 of gensets 110A-C along with renewable energy resources 135, power storage system 125 and any other power sources) and reduce down-time and maintenance costs. For example, predicting possible future failure scenarios and updating the operational parameters of the power sources, such as genset(s) 110, before a failure occurs allows the system to redistribute the active load to maintain a healthy network while still meeting the power output demands.

Without the ability to remotely predict failures and control power sources (e.g., renewable energy resources 135, power storage system 125, gensets 110A-C, etc.), a genset 110 or other power source may continue operating under non-ideal or even potential failure conditions until a failure occurs. Waiting until a failure occurs results in failure-based maintenance that is performed too late (e.g., after the failure occurs). Meanwhile performing static maintenance according to a pre-set maintenance schedule typically results in performing maintenance too early (e.g., while the component is still operating in a health zone), which increases the frequency of maintenance events, increases maintenance costs, and adds unnecessary downtime to power sources, such as a genset 110. On the other hand, predictive maintenance or condition-based maintenance is performed right-on-time or just-in-time instead of being too early or too late, which may result in decreased maintenance events and decreased downtime.

The DAQ module 140 may be adapted to determine the factors such as—likelihood of possible failures, severity and effect of such failures, approximate timeline for occurrence of such event and timeframe for maintenance schedule to prevent any severe breakdown as a preliminary action. Accordingly, the DAQ module 140 may estimate a safe operational timeframe (e.g., amount of hours the genset 110, solar cell 137, wind turbine 139, battery 127, etc. can continue to operate at current conditions before requiring maintenance or before reaching a predicted failure event) of individual power sources (e.g., gensets 110 in a genset chain 115). For example, data from various active mounted sensors may feed data to the DAQ module 140, which may then be processed and analyzed and compared to operation limits or thresholds. The operation limits or thresholds may be based on standard recommendations by the OEMs of each genset component (e.g., the engine, alternator, excitation system, batteries and other auxiliary devices including the sensors illustrated in FIGS. 2 and 3). In an example, each power source may have respective operation limits or thresholds based on standard recommendations by the respective OEMs that provide the power source.

Based on the processed data from the various sensor inputs, the cost functions (described in more detail below) of individual performance parameters of the power sources, such as gensets 110, may be determined. The cost functions may continually change based on the time period of data collection. For example, a linear regression technique (described in more detail below) and machine learning may be used in order to arrive at weighted cost functions of the individual parameters.

With the available data from various data interfaces of the engine, the active health status or safe operational timeframe of the power source(s) (e.g., gensets 110) is determined. Additionally, the future health status of the machines may be identified based on the regression analysis. If at any point, there is an abnormality predicted in the power source's performance due to an undesirable cause (e.g., rising winding temperature, deterioration of oil quality, increase in vibration of the system, etc.), then the DAQ module 140 may reevaluate the optimum running condition or safe operational timeframe and reallocate the system load to the healthier power sources. For example, system load may be reallocated from a genset 110 with a predicted abnormality to a healthier genset(s) 110 in the network or chain 115 or another power source in the network (e.g., a renewable energy resource). For example, the healthier gensets 110 are the gensets 110 with highest or longest safe operational timeframes. Load may be rebalanced allowing healthier gensets 110 or other healthy power sources to take on more of the power output requirements of the network, which helps extend the operational life of the other gensets 110 and power sources within the network that are at risk before a maintenance event is required.

By this way, the sudden drop out of one particular power source (e.g., genset 110) from the network leading to a catastrophic failure, such as power black-out, reverse power condition in other healthier sets, or overloading the network may be prevented. Secondly, the performance life of the gensets 110 or other power sources can be improved by continually re-evaluating current operating conditions and making dynamic or adaptive changes to the operating condition, which balances the load by applying an optimal loading point for each of the power sources (e.g., gensets 110, renewable energy resources 135, etc.) in the network based on the respective health status of each of the power sources.

In a genset specific example, based on the outcome of this machine learning algorithm, the intelligent decision making unit, such as the DAQ module 140, which may be embedded in the system is configured to send instructions through controller 120 to reduce the load on the running genset 110, call the next available genset 110 immediately parallel with the running genset 110 in order to reduce its load stress, transfer part of the load to other running gensets if the available spinning reserve capacity is sufficient, completely transfer the load to the next most healthy genset 110 in the network or call for immediate attention or manual intervention if there is no backup option available, based on the operational requirements. As such the proposed control solution for the multiple genset in parallel operation or genset in parallel to the utility power supply performs discrete control on the plant operation based on the health dynamics of the gensets. Similarly, instructions to reduce or increase load to other power sources may also be performed by DAQ module 140 and/or controller 120.

FIG. 3B illustrates a schematic view of various internal components and modules of controller 120. Controller 120 may include a power supply 390, a display 392, a control pad 394, a processor 395, a memory 385, a communication module(s) 396 (e.g., cellular communication module, Ethernet communication module, and/or a wireless communication module such as a WiFi communication module). The controller 120 may also include speakers 375 and a battery 385. Speakers 375 may emit audible signals to indicate when an alarm condition is present or when a failure event is predicted, to provide audible instructions to a technician, or to indicate a selection on control pad 230.

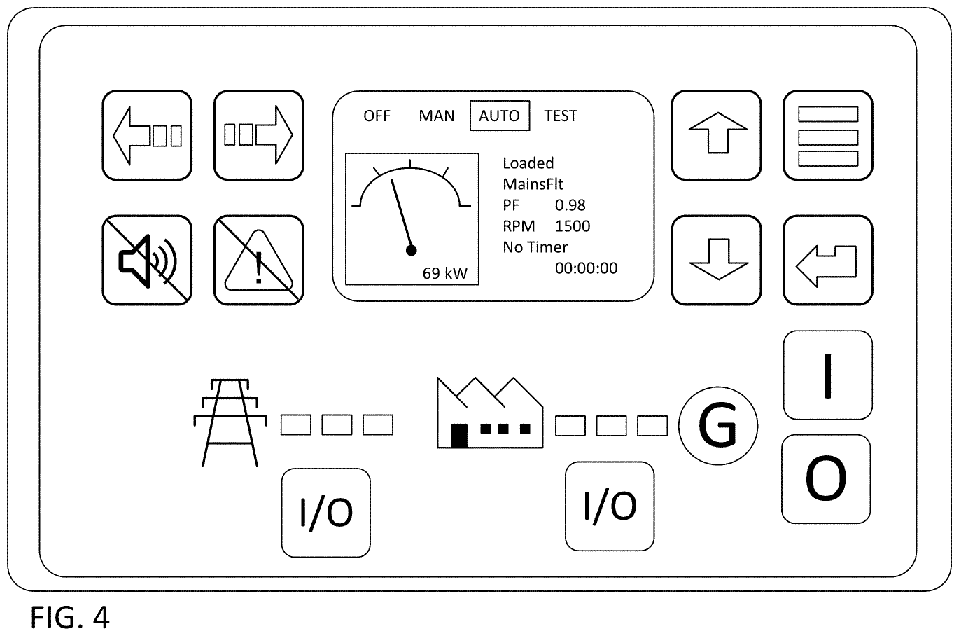

A technician may monitor operation outputs, control operational parameters of the power source (e.g., genset 110, solar cell 137, wind turbine 139, hydrogen cell and/or battery 127), edit set points, start or stop the power source, configure inputs and outputs, access and review alarm information and other event history information through the controller 120. For example, a technician may monitor a genset battery, alternator, lube oil, vibrations, bearings, exhaust temperature, genset RPMs, genset power output, etc. from various genset monitors, sensors and gauges while on-site at a genset facility using the controller 120. The technician may monitor other sensor outputs from various monitors, sensors and gauges while on-site at any of the other power source facilities using the controller 120. FIG. 4 illustrates an example user interface and layout of a controller 120, which is described in more detail in U.S. patent application Ser. No. 16/677,024 (incorporated herein by reference).

The communication module 396 (e.g., cellular communication module, Ethernet communication module, and/or WiFi communication module) may communicate with processors 395 and/or DAQ module 140 and may send data to the DAQ module 140. The communication module 395 may be used to communicate sensor data to the DAQ module 140. For example, the DAQ module 140 may communicate with controller 120 and also communicate with various sensors via an internet connection, through wireless (e.g., WiFi, Bluetooth, etc.) or through cellular based connections.

The controller 120 may be used to send control instructions and apply genset operating configurations to the genset 110. Additionally, controller 120 may be used to send control instructions and apply operation conditions to any of the other power sources illustrated in FIG. 1. The controller 120 may communicate with and receive instructions from the DAQ module 140. In an example, communication between controller 120, the DAQ module 140, and the power source(s) (e.g., genset 110, renewable energy resources 135, etc.) may be encrypted. For example, communication encryption may include over-the-air (“OTA”) encryption with WiFi Protected Access (“WPA”) or WiFi Protected Access II (“WPA2”). Additionally, communication between communication between controller 120, the DAQ module 140, and the power source(s) may utilize a communication protocol, such as Secured Sockets Layer (“SSL”), Transmission Control Protocol (“TCP”), Internet Protocol (“IP”) and Transport Layer Security (“TLS”) protocol to provide secure communication on the Internet for data transfers.

In the various examples described herein, the DAQ module 140 may analyze sensor data along with operation input data for each power source (e.g., genset 110, renewable energy resources 135, etc.) to predict future fault scenarios and redistribute load between the power source(s), such as gensets 110, in a network. The analysis may utilize various regression techniques and machine learning techniques or algorithms. For example, an optimization algorithm such as Stochastic Gradient Descent (“SGD”) may be used for machine learning. The optimization algorithm is adapted to determine a set of internal model parameters that perform well against a selected performance measure such as logarithmic loss or mean squared error. In SGD, “gradient” refers to the calculation of an error gradient or slope of error and “descent” refers to the moving down along that slope towards a minimum level of error. The algorithm is iterative and the learning process typically occurs over multiple discrete steps, where each step slightly improves the model parameters.

Each step involves using the model with the current set of internal parameters to make predictions on some samples, comparing the predictions to the real expected outcomes, calculating the error, and using the error to update the internal model parameters. The update procedure is different for different algorithms. In one example, a backpropagation update algorithm may be used.

For machine learning, multiple samples of data are required. A sample may also be called an instance, an observation, an input vector, or a feature vector. Additionally, a batch size may be established, which defines the quantity of samples to work through before updating the internal model parameters. For example, at the end of the batch, the predictions are compared to the expected output variables and an error is calculated. From this error, the update algorithm is used to improve the model, e.g. move down along the error gradient.

Different datasets may be used that include all available samples, one sample, a subset of samples, etc. For example, when all samples are used to create one batch, the machine learning algorithm is called batch gradient descent. When the batch is the size of one sample, the learning algorithm is called stochastic gradient descent. When the batch size is more than one sample and less than the size of the training dataset, the learning algorithm is called mini-batch gradient descent.

An epoch tracks the number times that the machine learning algorithm works through a data set. For example, one epoch means that each sample in the training dataset has had an opportunity to update the internal model parameters. Typically, the number of epochs is large, often hundreds or thousands, allowing the learning algorithm to run until the error from the model has been sufficiently minimized. While a batch size indicates a quantity of samples processed before the model is updated, the quantity of epochs indicates the number of complete passes through the training dataset. For example, the size of a batch must be more than or equal to one and less than or equal to the number of samples in the dataset. The number of epochs can be set to an integer value between one and infinity.

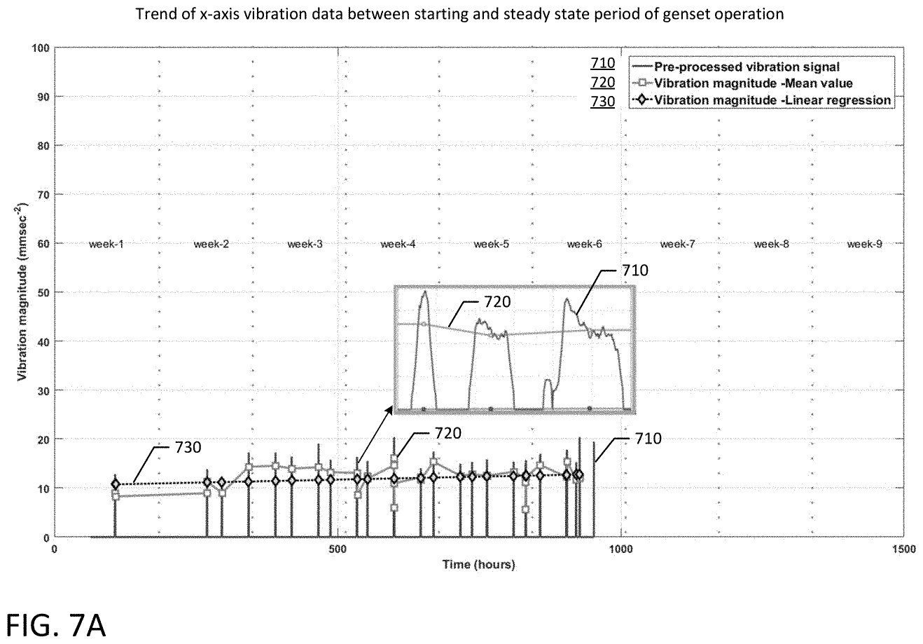

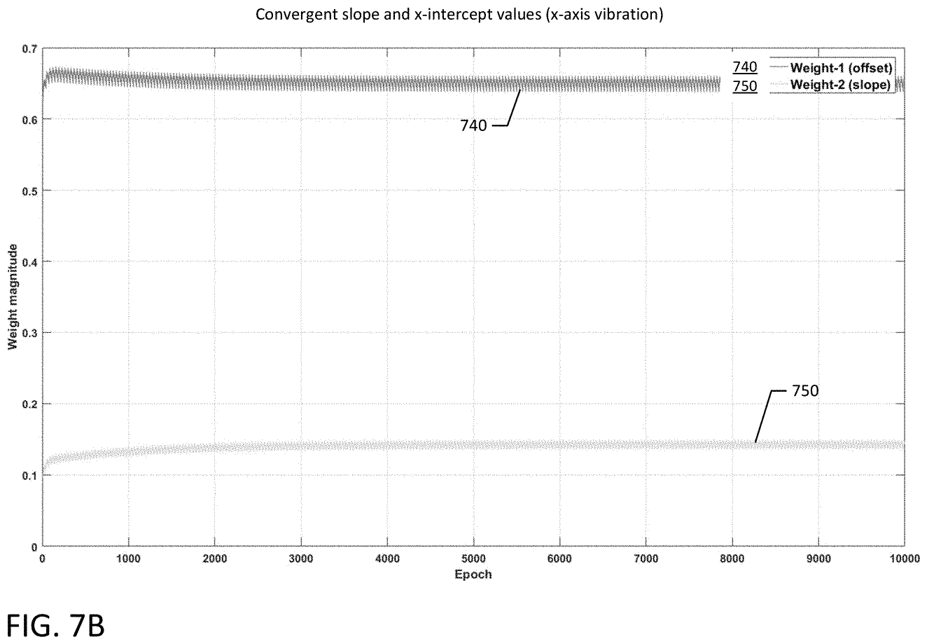

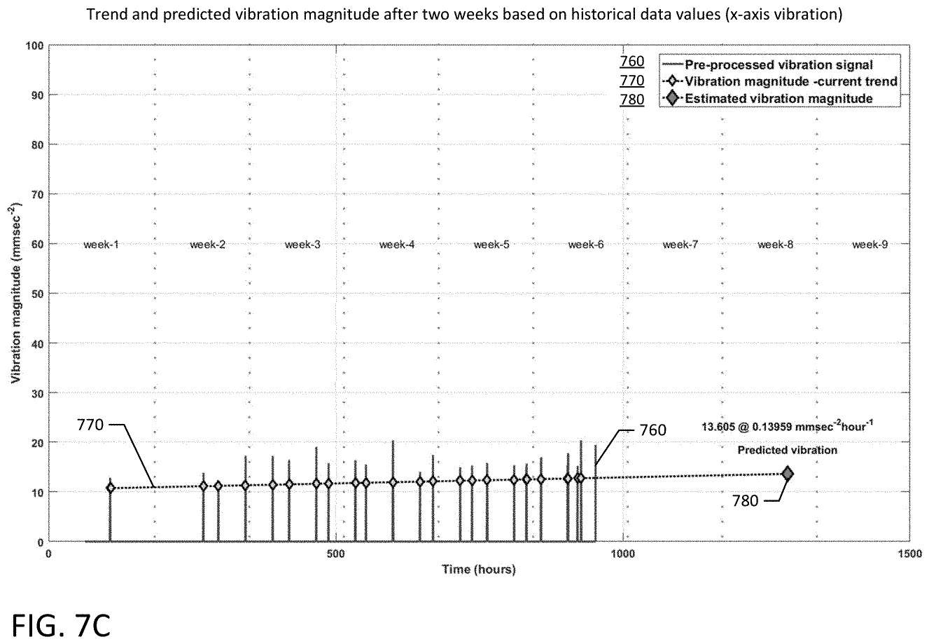

A trend of the x-axis vibration data may be established as illustrated in FIG. 7A-C. Specifically, vibration data may be collected from a generator set. For example, x-axis vibration data may be collected from an engine base plate of a generator set. The data may include the mean vibration magnitude (mm/sec²) for each engine start and stop interval. The x-axis vibration data may be processed to remove noise before obtaining the mean vibration magnitudes. Similarly, z-axis vibration data (e.g., pre-processed vibration signal(s) 710, vibration magnitudes and mean values 720, and linear regression values of the vibration magnitude 730) may be collected from the engine base plate of the generator set. As illustrated in FIG. 7A some samples appear to have multiple x-axis vibration magnitudes recorded (e.g., around the 600 hour mark), however this portion of time may have several engine stop and start intervals in a brief period of time (e.g., over the course of an hour or 30 minutes), which when compressed into x-axis shown in FIG. 7A (e.g., 0 hours to 1500 hours) appears to be a single event even though multiple vibration events were recorded at that time.

A linear regression of the mean vibration magnitude values may be performed to establish a trend of the x-axis vibration data. Then, a predicted vibration magnitude value may be determined based on the established trend. For example, a predicted vibration magnitude value (e.g., 13.605 mm/sec²) may be determined for two weeks in the future after machine learning and outputting a trend-line as illustrated in FIG. 7C. A similar analysis may occur for the z-axis vibration data to determine a predicated vibration magnitude value of 28.4211 mm/sec² for the z-axis vibration data.

For the x-axis vibration data and the z-axis vibration data, the weights may be the offset (b) and the slope (m) from Equation 1 (shown below), which may be optimized by performing several iterations or epochs as illustrated in FIG. 7B. For example, FIG. 7B illustrates that the model performed 10,000 epochs which resulted in a steady-state value for the offset (b) 740 and the slope (m) 750 of the best-fit line illustrated in FIG. 7C. As illustrated in FIG. 7C, the plot includes data, lines and/or trends for pre-processed vibration signals 760, a current trend of the vibration magnitude 770 and an estimated vibration magnitude 780.

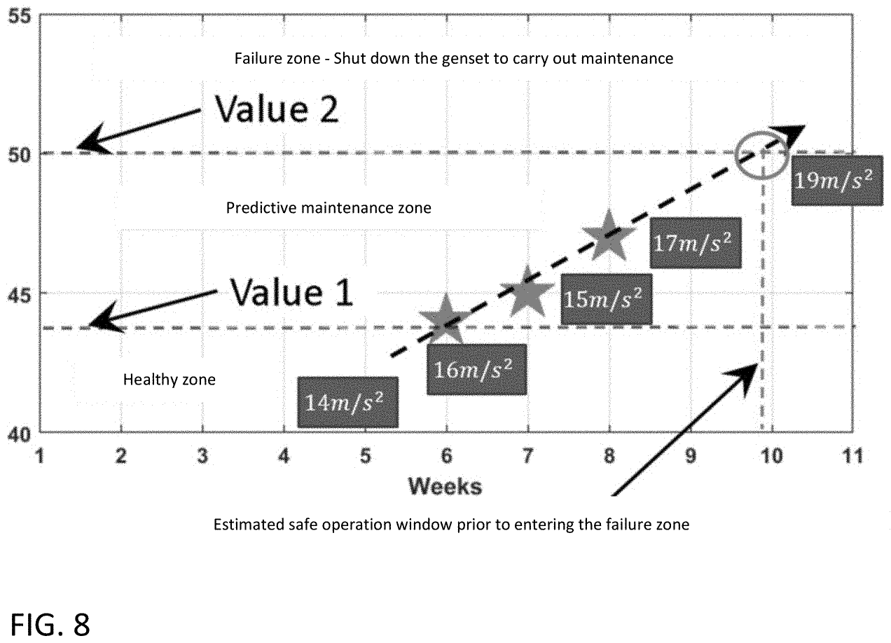

A similar type of analysis is illustrated in FIG. 8, which illustrates a predicted failure around week 10 due to the acceleration reaching 19 m/s². Prior to that point, the genset 110 may be taken offline prior to week 10 or the operation parameters may be dynamically changed to extend the safe operational lifetime of the genset 110 beyond 10 weeks.

Linear Regression is a supervised machine learning algorithm where the predicted output is continuous and has a constant slope. Linear regression may be used to predict values within a continuous range, (e.g., vibration magnitude, temperature, etc.). There are two main types including simple regression and multivariable regression.

Simple linear regression uses slope-intercept form (See Equation 1), where m and b are variables that the machine learning algorithm attempts to “learn” to produce the most accurate predictions. The variable x represents the input data and y represents the predicted value.

y=mx+b Equation 1:

Multi-variable linear regression may include one or more weights that the model attempts to learn. Additionally, the variables x, y, z represent attributes or other input data about specific observations.

f(x,y,z)=w₁x+w₂y+w₃z Equation 2:

For the vibration magnitude example, a multi-variable linear regression may be performed with two weights and two input variables or attributes.

The weights can be optimized using a cost function, such as a Mean Squared Error (“MSE”) function, which measures the average squared difference between an observation's actual and predicted values. The output is a single number representing the cost, or score, associated with the current set of weights. The goal is to minimize the MSE to improve the accuracy of the model. In the example of Equation 1, the MSE is provided below (see Equation 3), where N is the total number of observations (e.g., data points), yᵢ is the actual value of an observation and mxᵢ+b is the prediction.

$$M S E = \frac{1}{N} {\sum }_{i = 1}^{n} {( {y}_{i} - ( m {x}_{i} + b ) )}^{2} \qquad Equation 3$$

Training a model is the process of iteratively improving the prediction equation by looping through the dataset multiple times, each time updating the weight and bias values in the direction indicated by the slope of the cost function (e.g., gradient). The training or learning is complete when an acceptable error threshold is reached, or when subsequent training or learning iterations fail to reduce the cost. Before training, weights are initialized (e.g., set as default values) and other learning parameters may be set (e.g., learning rate and number of iterations).

Several sensed, measured, reported or calculated values may be combined when determining the health of a component. For example, outputs from various different sensors along with calculated values may each provide a health signal that are evaluated together to provide a single output health signal. However, with multiple input signals from various sources, the mathematical model or relationship between each of those signals may be unknown. For example, consider the following:

Inputs=x₁(i),x₂(i), . . . xₘ(i)

Mathematical model or relationship=“unknown system”

Output=d(i)

Given a set of observations of input-output data T: {x(i), d(i); i=1, 2, . . . n} where x(i)=[x₁(i), . . . , x₂(i), . . . , xₘ(i)]^{T} and (m=dimensionality of the input space) and (i=time index) an error signal e(i) at time (i) may be determined according to the equations below. For example, the error signal at time (i) may be defined according to Equation 4 below.

e(i)=d(i)−y(i) Equation 4:

Where e(i) may be used to adjust synaptic weights in the model for the “unknown system”, which may be determined mainly by the cost function used. The above parameters may be formulated as an optimization problem according to Equation 5.

E(w)=Σᵢ₌₁ⁿe(i)²=Σᵢ₌₁ⁿ(d(i)−y(i))² Equation 5:

The various inputs (e.g., data signals) can be evaluated according to the cost function above. Specifically, a linear model may be fit to a set of input-output pairs, such as (x(1), d(1)), (x(2), d(2)) (x(n), d(n)) observed in an interval of duration (n). In an example, the data or inputs may be fit to a linear neuron model. In a linear neuron model, which is a type of linear system where the input-output behavior is described in terms of a linear function. A neuron model mimics that of actual neurons where each neuron is thought of as a “device” having a number of inputs and a single output. The inputs consist of the currents generated by the synapses on the output consists of the action potentials carried by the axion. In a linear neuron model, each input x(i) may be multiplied by a corresponding weight w(i) and each of the resulting values are summed together to form the output y(i). Thus, the output is given as a function of the inputs and weights according to Equation 6 below, which is a Linear Neuron (single-layer perception without squash function) model.

y(i)=v(i)Σₖ₌₀ⁿwₖ(i)xₖ(i)=w′^{T}(i)·x′(i) Equation 6:

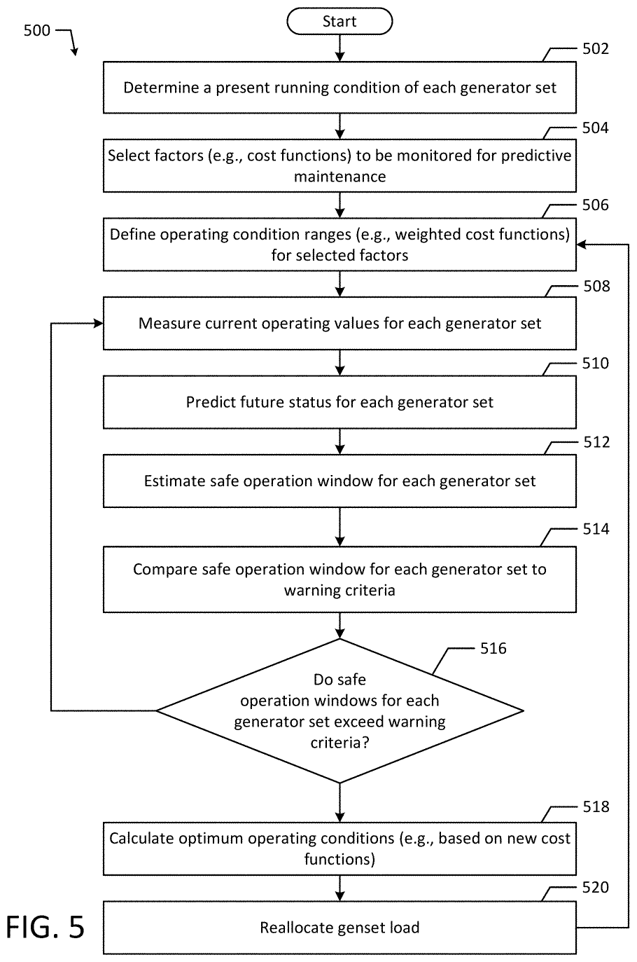

FIG. 5 illustrates a flowchart of an example method 500 for predicting a fault scenario and reallocating genset load according to an example of the present disclosure. Although the example method 500 is described with reference to the flowchart illustrated in FIG. 5, it will be appreciated that many other methods of performing the acts associated with the method 500 may be used. For example, the order of some of the blocks may be changed, certain blocks may be combined with other blocks, and some of the blocks described are optional. The method 500 may be performed by processing logic that may comprise hardware (circuitry, dedicated logic, etc.), software, or a combination of both

Method 500 is an illustrative example specific to genset(s) 110, but it should be appreciated that the method 500 may be extended to other power sources. Method 500 includes determining a present running condition of each generator set (block 502). In an example, the present running condition may be determined by current sensor outputs or information about the current state of each genset, which may be collected by DAQ module 140 or controller 120. The present running condition of each genset 110 may also be estimated or calculated based on sensor information (e.g., for information that cannot be directly measured by a sensor). Then, method 500 includes selecting factors (e.g., cost functions) to be monitored for predictive maintenance (block 504). A cost function regarding battery health may be monitored to determine when a battery should be replaced. After the factors (e.g., cost functions) are identified, operating condition ranges are defined for the selected factors (block 506).

For example, operating condition ranges may include a healthy range, a maintenance range, and a shut-down range. Operating condition ranges may also be thought of as “zones” that the genset 110 operates in, such as a healthy zone, a maintenance zone, or a shut-down zone. In the maintenance range or zone, the genset 110 can still be used, however in the shut-down zone, the genset 110 should be shut-down because component failure may be imminent. The operation limits or operating condition ranges may be based on standard recommendations provided by an OEM or other established specification.

Once the factors are selected and the operating condition ranges are identified, method 500 includes measuring current operating values for each genset 110 (block 508). For example, operating values may be measured or reported from sensors, such as a battery state of health sensor 310 or a battery state of charge sensor 312.

Method 500 also includes predicting a future status for each genset 110 (block 510). For example, the current operating values for each genset may be extrapolated to predict future operating values or the future status for each genset 110. Then, the method includes estimating a safe operation window for each genset 110 (block 512). The predicted future operating values or operating status may be analyzed to determine the safe window for each genset. For example, the safe operation window may be a window of time (e.g., amount of hours) the genset can safely operate at before a monitored factor or value (e.g., battery health, lube oil temperature, etc.) reaches shut-down range. The window may be bounded by time (e.g., in the x-direction) and the height of the window may be bounded by a monitored factor or value (e.g., battery health, lube oil temperature, etc.). Once the monitored factor or value is estimated to reach a shut-down range that time and range serve as the end bounds of the window.

In some instances, the safe operation window may be the smallest window of time based on various different factors. For example, the safe operation window based on battery data may be 240 hours (e.g., 10 days) while the safe operation window based on the lube oil sensor may be 120 hours (e.g., 5 days), which indicates that the safe operation window for the genset is 120 hours (e.g., 5 days) before the lube oil needs to be replaced.

As noted above, several measured or reported operating values along with any calculated values may be combined when monitoring or determining the health of a component. For example, outputs from various different sensors along with calculated values may each provide a health signal that is evaluated together. In one illustrative example, energy efficiency for a genset 110 may be calculated from actual power [kW] and gas flow [m³/h], which may be a monitored value to determine the health of the genset 110. The accurate modeling of the fuel consumption may be especially important when scheduling or controlling the genset(s) for optimized power generation.

Then, the method 500 includes comparing the safe operation window for each genset 110 to warning criteria (block 514). The safe operation window based on battery data may be 240 hours (e.g., 10 days) while the safe operation window based on the lube oil sensor may be 120 hours (e.g., 5 days), which would indicate that after 120 hours, the monitored factor for the lube oil sensor would exceed a warning criteria threshold while the monitored factor (e.g., battery charge) for the battery monitor would still be in a safe operational range without exceeding the warning criteria. Each of the safe operation windows for each generator is evaluated as to whether they exceed warning criteria (block 516). If warning criteria are not exceeded, then the method continues to measure operating values for each genset 110 and updates the safe operation window estimates based on the additional data.

However, if the warning criteria (e.g., safety thresholds) are exceeded, then method 500 includes calculating optimum operating conditions (block 518). For example, the genset 110 may be originally configured with a first set of operating conditions (e.g., set at a predetermined RPM, etc.) and a second set of operating conditions may be calculated to improve the lifetime of various component parts of the genset 110, such that a failure may be delayed or prevented. The second set of operating conditions may include a lower RPM than what the genset is currently operating at to reduce stresses or vibrations that the genset 110 is currently experiencing. This second set of operating conditions may be considered optimum operating conditions, which would extend the safe operation window such that the network of gensets 110 can operate in a safe zone for a longer period of time before a maintenance event takes place. Based on the calculated optimum operating conditions, the genset load is reallocated across the gensets 110 (block 520). For example, if the optimum operating conditions (e.g., second set of operating conditions) for genset 110B indicate that it has to operate at a lower RPM to reduce oil temperature, reduce vibrations or extend battery life, then the operational load of genset 110B may be reduced to 20 percent while the operational load of gensets 110A and 110C are increased to 40 percent.

It should be appreciated than an optimum operating condition may be an operating condition that improves a failure metric, such as reducing vibration or reducing oil temperature to extend the healthy operational life of a genset 110 compared to the genset's current operating conditions. In other examples, an optimum operating condition may be based on several failure metrics, such that the new operating condition extends the collective life of a group of genset components even though a different operating condition may be more beneficial for a single genset component in the group of components.

As described above, the predictive features of method 500 not only provide the capability to predict the failure of an active mechanical/electrical system of the genset 110 in order to prevent the likelihood of a possible breakdown situation, but also provides the capability to dynamically act on the genset network and make an intelligent decision on how to dynamically change the operating conditions in order to prevent undesired scenarios that can cause severe damages to the genset or fault in the network leading to power failure situations of one or more gensets 110 in a genset network.

As noted above, method 500 is an illustrative example specific to genset(s) 110. However, the method 500 may be applied to any of the other power sources in the network (e.g., each of the power sources illustrated and described in relation to FIG. 1). For example, the method may include determining a present running condition of each power source (e.g., renewable energy resources), selecting factors to be monitored for predictive maintenance, defining operation condition ranges for the selected factors, measuring current operation values for each power source, and predicting a future status for each power source. The method may also include estimating safe operation windows for each power source, comparing the safe operation window for each power source to warning criteria, determining if the safe operation windows exceed the warning criteria, calculating optimum operation conditions, and reallocation load where necessary to other power sources in the network.

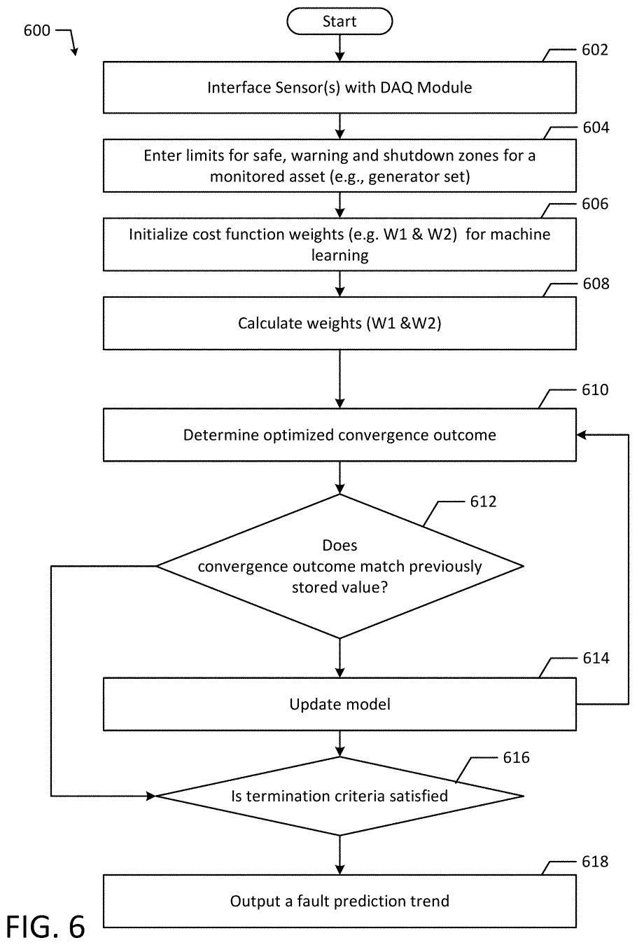

FIG. 6 illustrates a flowchart of an example method 600 for predicting a fault scenario according to an example of the present disclosure. Although the example method 600 is described with reference to the flowchart illustrated in FIG. 6, it will be appreciated that many other methods of performing the acts associated with the method 600 may be used. For example, the order of some of the blocks may be changed, certain blocks may be combined with other blocks, and some of the blocks described are optional. The method 500 may be performed by processing logic that may comprise hardware (circuitry, dedicated logic, etc.), software, or a combination of both

First, sensor(s) are interfaced with a DAQ module 140 (block 602). For example, each sensor may interface with the DAQ module 140. In another example, a portion of the sensors monitoring a power source, such as genset 110, may be interfaced with the DAQ module 140. Then, the limits for safe, warning and shut-down zones may be entered for a monitored asset (block 604). The monitored asset may be a genset 110 (e.g., genset 110A) or a specific component of the genset 110 (e.g., genset battery, genset radiator, genset engine, etc.). In another example, the monitored asset may be any of the power sources illustrated or described in relation to FIG. 1. Similarly, the monitored asset may be a specific component of any of the power sources illustrated in FIG. 1 (e.g., yaw motor, yaw drive, generator, rotor, etc. of a wind turbine 139). The limits for safe, warning and shutdown zones for the monitored asset may be provided by the OEM. For example, operation limits or thresholds may be based on standard recommendations published by an OEM or other standards body. These limits may be used to determine safe, warning and shutdown zones. For example, a shutdown zone may be set at a level that is 10 percent lower than a maximum recommended oil temperature or a level that is 15 percent higher than a minimum battery charge capacity for a battery. By setting a shutdown zone in this manner, the genset 110 can be shut down for maintenance before an unexpected failure occurs. Similarly, other power sources may be shut down for maintenance before an unexpected failure occurs.

Then, method 600 includes initializing cost function weights (e.g., W1 and W2) for machine learning (block 606). For example, the W1 may correspond to an offset and W2 may correspond to a slope of a best fit line of sensor data (e.g., x-axis vibration data vs. time). The cost function weights (e.g., W1 and W2) may be initialized with a random value, a predetermined integer, or a value based on previous analysis. For example, previous fault prediction analysis may have indicated that the values for W1 and W2 are typically 13 and 0.5 respectively, so those values may be used as the initialization values.

After initializing the cost function weights, the weights are calculated (block 608). In an example, the weights may be calculated using a neural network. A neural networks may include set of algorithms that are designed to recognize patterns. For example, the neural network may interpret sensor data to find correlations from the input data and help with future predictions (e.g., fault predictions). After calculating the weights, method 600 includes determining an optimized outcome (block 610). For example, a model may be iterated multiple times (e.g., run for multiple epochs) until a satisfactory convergence of the weights (e.g., W1 and W2) occurs.

Then, the method includes determining if the convergence outcome matches previously stored values (block 612). For example, the method determines if the convergence outcome has changed from the previous iteration. If the outcome has changed and progress is being made, then the model is updated and another iteration is made (block 614).

In some scenarios a mistake may be made when entering limits or a sensor may be damaged, which is providing faulty sensor data, which may cause the optimized convergence outcome to be incorrect. Therefore, the convergence outcome may be compared to previously stored values for similar data to ensure the accuracy of the convergence outcome. Additionally, faulty sensors may be replaced with new sensors, different initialization values for the cost function weights may be used, and limits for the various zones may be checked and modified if an error exists.

If the convergence outcome does not match previously stored values, the model may be updated (block 614). For example, another iteration may be run to determine a more optimized convergence outcome. If the convergence outcome matches the stored value, then method 600 may determine if a termination criteria is satisfied (block 616). For example, to ensure that the model has a limit on the amount of iterations performed, there may be a termination criteria or threshold number of epochs that are run.

If the termination criteria is satisfied, then method 600 includes outputting a fault prediction trend line (block 618). For example, the DAQ module 140 may output a sensor data trend line that indicates when a fault is likely to occur based on OEM guidelines. The trend line may be created using linear regression analysis. The results may indicate a past, a current and a future trend of each sensor data being sampled and based on operational guidelines for a specific generator set. In an example, the data visualizations may be provided to allow the user to review operational parameters along with the past, current and future trends of the sensor data to schedule a maintenance event for the power source (e.g., genset 110, solar cell 137, wind turbine 139, battery 127, etc.).

Even if the termination criteria is not satisfied, the model may move on to block 618 if the convergence outcome at block 610 matches the previously stored value, which may indicate that the model is fully optimized (e.g., no additionally epochs are required).

As used herein, physical processor or processor 380, 395 refers to a device capable of executing instructions encoding arithmetic, logical, and/or I/O operations. In one illustrative example, a processor may follow Von Neumann architectural model and may include an arithmetic logic unit (“ALU”), a control unit, and a plurality of registers. In a further aspect, a processor may be a single core processor which is typically capable of executing one instruction at a time (or process a single pipeline of instructions), or a multi-core processor which may simultaneously execute multiple instructions. In another aspect, a processor may be implemented as a single integrated circuit, two or more integrated circuits, or may be a component of a multi-chip module (e.g., in which individual microprocessor dies are included in a single integrated circuit package and hence share a single socket). A processor may also be referred to as a central processing unit (“CPU”). Additionally a processor may be a microprocessor, microcontroller or microcontroller unit (“MCU”).

As discussed herein, a memory device or memory 384, 385 refers to a volatile or non-volatile memory device, such as random access memory (“RAM”), read-only memory (“ROM”), electrically erasable programmable read-only memory (“EEPROM”), or any other device capable of storing data. Processors 380, 395 may be interconnected using a variety of techniques, ranging from a point-to-point processor interconnect, to a system area network, such as an Ethernet-based network.

Case Study

In an example, at a typical cell tower, the power demand is determined by the number of base transceiver stations housed. The power demand ranges from 1 kW to 8.5 kW where more than 80 percent of these configurations have a demand less than 3.5 kW. To ensure power availability of more than 99.95 percent, tower owners' backup the electrical grid with a combination of batteries and diesel generator. When the power from the grid is interrupted, the controller (e.g., controller 120) sends a signal to the genset 110 to turn on and the genset 110 comes online and supports the entire power requirement at the site. During the transition of supply from the electricity grid to the genset 110, batteries may provide the power required by telecommunication equipment at the tower and ensure uninterrupted operation of the telecom site.

Typical maintenance costs are described in Table 1 below in Singapore dollars (“SGD”). The maintenance costs include genset maintenance costs, battery maintenance costs, power interface unit (“PIU”) maintenance costs and switched mode power supply (“SMPS”) maintenance costs.

TABLE 1
Operation and Maintenance Costs
Genset maintenance costs

| | | |
|---|---|---|
| Preventive maintenance costs | SGD/visit | 750 |
| Frequency of visit | hrs/visit | 3 |
| Effective cost of preventive maintenance | SGD/hr | 2.5 |
| Minor overhaul cost | SGD | 1,200 |
| Frequency of minor overhaul | hrs | 5,000 |
| Cost of generator rental during overhaul | SGD | 500 |
| Major overhaul cost | SGD | 2,500 |
| Frequency of major overhaul | hrs | 10,000 |
| Cost of generator rental during overhaul | SGD | 750 |
| Total cost of overhaul during life of gen | SGD | 4950 |
| Effective cost of overhauls for generator | SGD/hr | 0.33 |
| Other costs for unscheduled maintenance | SGD/year | 1,000 |
| Average diesel generator maintenance costs/day | SGD/day | 6.52 |

Battery, Power Interface Unit (“PIU”) and Switched
Mode Power Supply (“SMPS”) maintenance costs

| | | |
|---|---|---|
| Preventive maintenances costs | SGD/visit | 750 |
| Frequency of visit | days/visit | 91 |
| Other costs for unscheduled maintenance | SGD/year | 2000 |
| Average maintenance costs of battery etc. | SGD/day | 13.69 |

Predictive maintenance of power sources (e.g., gensets 110) advantageously predicts future failures or faults in advance through optimized computational algorithms and allows more up-time for the power sources (e.g., gensets 110) to meet rapidly growing energy demands. For example, machine learning may be implemented to maximize the power generated by the power sources, such as gensets 110. Specifically, condition based machine learning algorithms may be designed to minimize maintenance and operation down time and to generate the maximum power from each of the power sources in the network.

Data indicates that predictive maintenance is extremely cost effective, for example, putting a functional predictive maintenance program in place may yield a tenfold increase in ROI, a 25 percent to 30 percent reduction in maintenance costs, a 70 percent to 75 percent decrease of breakdown occurrences and a 35 percent to 45 percent reduction in downtime. When savings are expressed per labor hour, predictive maintenance costs approximately 9 dollars hourly pay per annum while preventive maintenance costs approximately 13 dollars hourly pay per annum resulting in a savings of approximately 30 percent.

Aspects of the subject matter described herein may be useful alone or in combination with one or more other aspects described herein. In a first exemplary aspect of the present disclosure, a system includes a plurality of power sources including a plurality of generator sets connected in parallel, a controller, and a data acquisition and analysis module. The data acquisition and analysis module is configured to receive sensor data from a sensor, analyze the sensor data, and predict a future fault scenario at a first time.

In accordance with another exemplary aspect of the present disclosure, which may be used in combination with any one or more of the preceding aspects, the data acquisition and analysis module is further configured to send at least one of a signal analysis and a prediction to an operator based on an abnormality in an operation of at least one of the plurality of power sources.

In accordance with another exemplary aspect of the present disclosure, which may be used in combination with any one or more of the preceding aspects, the data acquisition and analysis module is further configured to send an instruction to the controller to change an operational parameter of a respective power source of the plurality of power sources. Additionally, the instruction may be configured to delay the fault scenario to a second time after the first time.

In accordance with another exemplary aspect of the present disclosure, which may be used in combination with any one or more of the preceding aspects, at least one of the controller and the data acquisition and analysis module further includes at least one speaker configured to emit an audible alarm signal.

In accordance with another exemplary aspect of the present disclosure, which may be used in combination with any one or more of the preceding aspects, the sensor is one of a battery monitor, an alternator winding temperature sensor, a lube oil quality monitor, a structural vibration sensor, a bearing failure sensor, an exhaust temperature sensor, an ambient temperature sensor, a throttle position sensor, an air filter pressure sensor, a gals flow sensor, and a lube oil pressure sensor.

In accordance with another exemplary aspect of the present disclosure, which may be used in combination with any one or more of the preceding aspects, predicting a future fault scenario includes at least one of performing a regression analysis and using machine learning.

In accordance with another exemplary aspect of the present disclosure, which may be used in combination with any one or more of the preceding aspects, the regression analysis is at least one of a simple linear regression and a multi-variable linear regression.

In accordance with another exemplary aspect of the present disclosure, which may be used in combination with any one or more of the preceding aspects, the machine learning uses a neural network.

In accordance with another exemplary aspect of the present disclosure, which may be used in combination with any one or more of the preceding aspects, predicting a future fault scenario utilizes a stochastic gradient descent analysis.

In accordance with another exemplary aspect of the present disclosure, which may be used in combination with any one or more of the preceding aspects, the system further includes a communication server, and communication between the controller and the data acquisition and analysis module is routed via the communication server.

In accordance with another exemplary aspect of the present disclosure, which may be used in combination with any one or more of the preceding aspects, the data analytics model is further configured to reallocate genset load of the generator set based on the future genset fault scenario.

Aspects of the subject matter described herein may be useful alone or in combination with one or more other aspects described herein. In a 2nd exemplary aspect of the present disclosure a method includes measuring current operating values for at least one power source that is configured with first operating conditions, estimating a safe operation window for the at least one power source, and comparing the safe operation window to a warning criteria. The method also includes calculating second operating conditions for the at least one power source. The second operating conditions are different than the first operating conditions. Additionally, the method includes reallocating a load for the at least one power source based on the second operating conditions for the at least one power source.

In accordance with another exemplary aspect of the present disclosure, which may be used in combination with any one or more of the preceding aspects, the at least one power source is a genset and the load is a genset load.

In accordance with another exemplary aspect of the present disclosure, which may be used in combination with any one or more of the preceding aspects, measuring current operating values for the at least one power source includes receiving sensor data from a sensor.

In accordance with another exemplary aspect of the present disclosure, which may be used in combination with any one or more of the preceding aspects, the sensor is one of a battery monitor, an alternator winding temperature sensor, a lube oil quality monitor, a structural vibration sensor, a bearing failure sensor, an exhaust temperature sensor, an ambient temperature sensor, a throttle position sensor, an air filter pressure sensor, a gas flow sensor, and a lube oil pressure sensor.

In accordance with another exemplary aspect of the present disclosure, which may be used in combination with any one or more of the preceding aspects, estimating a safe operation window for the at least one power source includes performing a regression analysis.

In accordance with another exemplary aspect of the present disclosure, which may be used in combination with any one or more of the preceding aspects, the regression analysis is at least one of a simple linear regression and a multi-variable linear regression.

Aspects of the subject matter described herein may be useful alone or in combination with one or more other aspects described herein. In a 3rd exemplary aspect of the present disclosure a method includes establishing limits for sensor data. The sensor data is obtained by one or more sensors configured to monitor at least one power source. The method also includes initializing a first cost function weight and a second cost function weight associated with the sensor data, determining convergence values for the first cost function weight and the second cost function weight using machine learning, and outputting a trend line based on the sensor data based on a regression analysis of the sensor data and the convergence values for the first cost function weight and the second cost function weight. Additionally, the method includes dynamically adjusting at least one operating parameter of the at least one power source based on the fault scenario prediction. The at least one operating parameter is related to the sensor data.

In accordance with another exemplary aspect of the present disclosure, which may be used in combination with any one or more of the preceding aspects (e.g., the 16th aspect), the method further includes predicting a fault scenario for a component of the at least one power source based on the trend line.

In accordance with another aspect of the present disclosure, which may be used in combination with any one or more of the preceding aspects, the sensor is one of a battery monitor, an alternator winding temperature sensor, a lube oil quality monitor, a structural vibration sensor, a bearing failure sensor, an exhaust temperature sensor, and a lube oil pressure sensor.

In accordance with another exemplary aspect of the present disclosure, which may be used in combination with any one or more of the preceding aspects, the method further includes outputting a second trend line after adjusting the at least one operating parameter of the at least one power source.

In accordance with another exemplary aspect of the present disclosure, which may be used in combination with any one or more of the preceding aspects, the first cost function weight and the second cost function weight are initialized with previously determined convergence values.

In accordance with another exemplary aspect of the present disclosure, which may be used in combination with any one or more of the preceding aspects, the at least on power source includes at least one of a genset, a solar cell, a hydrogen cell, a wind turbine, and a battery.

The many features and advantages of the present disclosure are apparent from the written description, and thus, the appended claims are intended to cover all such features and advantages of the disclosure. Further, since numerous modifications and changes will readily occur to those skilled in the art, the present disclosure is not limited to the exact construction and operation as illustrated and described. Therefore, the described embodiments should be taken as illustrative and not restrictive, and the disclosure should not be limited to the details given herein but should be defined by the following claims and their full scope of equivalents, whether foreseeable or unforeseeable now or in the future.

To the extent that any of these aspects are mutually exclusive, it should be understood that such mutual exclusivity shall not limit in any way the combination of such aspects with any other aspect whether or not such aspect is explicitly recited. Any of these aspects may be claimed, without limitation, as a system, method, apparatus, device, medium, etc.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A system comprising:
a plurality of power sources including a plurality of generator sets connected in parallel;
a controller; and
a data acquisition and analysis module configured to:
receive sensor data from a sensor,
analyze the sensor data, and
predict a future fault scenario at a first time associated with at least one of the power sources.

2. The system of claim 1, wherein the data acquisition and analysis module is further configured to send at least one of a signal analysis and a prediction to an operator based on an abnormality in an operation of at least one of the plurality of power sources.

3. The system of claim 1, wherein the data acquisition and analysis module is further configured to send an instruction to the controller to change an operational parameter of a respective power source of the plurality of power sources, wherein the instruction is configured to delay the fault scenario to a second time after the first time.

4. The system of claim 1, wherein at least one of the controller and the data acquisition and analysis module further includes at least one speaker configured to emit an audible alarm signal.

5. The system of claim 1, wherein the sensor is one of a battery monitor, an alternator winding temperature sensor, a lube oil quality monitor, a structural vibration sensor, a bearing failure sensor, an exhaust temperature sensor, an ambient temperature sensor, a throttle position sensor, an air filter pressure sensor, a gas flow sensor, and a lube oil pressure sensor.

6. The system of claim 1, wherein predicting a future fault scenario includes at least one of performing a regression analysis and using machine learning.

7. The system of claim 6, wherein the regression analysis is at least one of a simple linear regression and a multi-variable linear regression.

8. The system of claim 6, wherein the machine learning uses a neural network.

9. The system of claim 6, wherein predicting a future fault scenario utilizes a stochastic gradient descent analysis.

10. The system of claim 1, further comprising a communication server, wherein communication between the controller and the data acquisition and analysis module is routed via the communication server.

11. The system of claim 1, wherein the data analytics model is further configured to reallocate a respective load of at least one of the plurality of generator sets based on the future fault scenario.

12. A method comprising:
measuring current operating values for at least one power source that is configured with first operating conditions;
estimating a safe operation window for the at least one power source;
comparing the safe operation window to a warning criteria;
calculating second operating conditions for the at least one power source, wherein the second operating conditions are different than the first operating conditions; and
reallocating a load for the at least one power source based on the second operating conditions for the at least one power source.

13. The method of claim 12, wherein the at least one power source is a genset and the load is a genset load.

14. The method of claim 12, wherein measuring current operating values for the at least one power source includes receiving sensor data from a sensor.

15. The method of claim 14, wherein the sensor is one of a battery monitor, an alternator winding temperature sensor, a lube oil quality monitor, a structural vibration sensor, a bearing failure sensor, an exhaust temperature sensor, an ambient temperature sensor, a throttle position sensor, an air filter pressure sensor, a gas flow sensor, and a lube oil pressure sensor.

16. The method of claim 12, wherein estimating a safe operation window for the at least one power source includes performing a regression analysis, and wherein the regression analysis is at least one of a simple linear regression and a multi-variable linear regression.

17. A method comprising:
establishing limits for sensor data, wherein the sensor data is obtained by one or more sensors configured to monitor at least one power source;
initializing a first cost function weight and a second cost function weight associated with the sensor data;
determining convergence values for the first cost function weight and the second cost function weight using machine learning;
outputting a trend line based on the sensor data based on a regression analysis of the sensor data and the convergence values for the first cost function weight and the second cost function weight; and
dynamically adjusting at least one operating parameter of the at least one power source based on the fault scenario prediction, wherein the at least one operating parameter is related to the sensor data.

18. The method of claim 17, further comprising:
predicting a fault scenario for a component of the at least one power source based on the trend line; and
outputting a second trend line after adjusting the at least one operating parameter of the at least one power source.

19. The method of claim 17, wherein the first cost function weight and the second cost function weight are initialized with previously determined convergence values.

20. The method of claim 17, wherein the at least one power source includes at least one of a genset, a solar cell, a hydrogen cell, a wind turbine, and a battery.
